(19) United States
(12) Patent Application Publication
(10) Pub. No.: US 2011/0015341 A1
(43) Pub. Date: Jan. 20, 2011

(54) Phenol-Formaldehyde Resins, Method for the Production Thereof and Use Thereof as Binders

(75) Inventors: Stefan Kowatsch, Weinzierl (AT); Karl Loidolt, Krems (AT); Christoph Prock, Zwettl (AT)

Correspondence Address: COHEN, PONTANI, LIEBERMAN & PAVANE LLP, 551 FIFTH AVENUE, SUITE 1210, NEW YORK, NY, 10176, US

(73) Assignee: Dynea Oy, Helsinki (FI)

(21) Appl. No.: 12/523,835

(22) PCT Filed: Jan. 21, 2008
(86) PCT No.: PCT/AT08/00018

§ 371 Date: Jan. 18, 2010

(30) Foreign Application Priority Data
Jan. 19, 2007 (AT) A 96/2007

(51) Int. Cl. C08L 61/06; C08G 8/10

(52) U.S. Cl. 524/594; 528/144; 528/146; 528/137; 528/138

(57) ABSTRACT

A phenol-formaldehyde resin, which can be obtained by alkalinically catalyzed condensation of phenol and formaldehyde in the presence of at least one salt of inorganic acids and by neutralization by means of an inorganic or organic acid following the condensation, wherein the production takes place with the addition of at least one compound of the formula R¹—(CH₂)ₙ—R², in which R¹ and R², independently of one another, stand for —C(O)R, —COOR, —CN, or —NO₂, and R represents H or CH₃, and n has the value of 1 or 2. Also disclosed are the production of such resins and their use as binders for mineral-fiber-based insulating products.

The present invention relates to phenol-formaldehyde resins, their production, and their use, especially as binders for mineral-fiber-based insulating products, as well as mineral-fiber-based insulating products which contain these phenol-formaldehyde resins as binders.

In technology, phenol-formaldehyde resins and compositions containing these resins are used, if necessary with the addition of additives, among other purposes as binders for mineral-fiber-based insulating products. Such insulating products are used for instance in public and community residential construction, as wall and roof insulation, and in industry, for instance in the form of various kinds of technical insulation.

To be usable as such binders, the phenol-formaldehyde resins must have adequate stability, so that after the production and before further processing, especially into mineral-fiber-based insulating products, essentially no further condensation occurs that would make the phenol-formaldehyde resins unfit for use as binders. One important criterion made of resins for such applications is the capability of flowing on the surface of the mineral fibers to the points of intersection with other mineral fibers, so as to achieve a mechanical fixation there after curing has taken place. Uncontrolled further condensation of the phenol-formaldehyde resins creates increasingly higher-molecular oligomers that do not have the necessary rheological behavior. Water-soluble and mono-, di- and trisubstituted phenol derivatives are therefore the preferred substance elements, since they are capable of migrating to the points of intersection of the mineral fibers and upon curing can form a stable network. For the production of mineral-fiber-based insulating products, the binders must also maintain the capability of infinite water dilutability over a relatively long period of time. The term “infinite water dilutability” is understood here to mean that in accordance with DIN standard 16916, a predetermined quantity of resin can be mixed with arbitrary quantities of softened warm water at 20° C., without the occurrence of precipitates.

Moreover, because of strict requirements with regard to the maximum allowable concentration values and the emission limit values permitted, especially in the case of the phenol-formaldehyde resins to be used as binders for mineral fibers, the process-dictated splitting off of all volatile substances and in particular splitting off of ammonia must be minimized. Besides these environmental and health-related aspects, a reduction in volatile substances also has significant advantages in terms of the efficiency of the binder systems employed and thus also has a lasting overall economic advantage.

With binders but especially in mineral-fiber-based insulating products, in order to assure reduced splitting off or no splitting off at all of volatile substances, the majority of raw materials used must be converted into a polycondensed network. As a result, as a rule, maximum mechanical strength properties can also be attained, such as tensile and compressive strength, compressibility and shape recovery, while preserving the relevant heat transition coefficients that are relevant for mineral-fiber-based insulating products.

To avoid in particular an emission of excess free formaldehyde from the phenol-formaldehyde resins, formaldehyde collectors are added to them even during or immediately after the production of the resins, but often also not until immediately before the phenol-formaldehyde resins are used for producing the insulating products. Urea is a long-known and widely used formaldehyde collector. The well-known advantages of urea are its availability and low cost.

The use of urea as a formaldehyde collector in binders based on phenol formaldehyde for mineral-fiber-based insulating products, however, also has a substantial disadvantage, if by thermal reactions, components of the urea are converted into organic amines and ammonia and those substances are given off during the production process or from the finished product. For instance, even in the case of fire, although it is true that the nitrogen content of the urea has a favorable effect on the fire behavior, the release of such potentially dangerous substances must be taken into account especially on the occurrence of temperatures above 350° C.

A further disadvantage of the use of urea as a formaldehyde collector is the lower hydrolysis stability of its reaction products with formaldehyde. This means that despite the formation of oligomeric and polymeric structures in the precursors of the urea-formaldehyde resin or in the condensed-out resins, cleavage of these bonds can occur by the action of moisture, and thus during the use of the insulating products, slight but demonstrable quantities of formaldehyde can again be formed and released.

The objects of the invention are to minimize cleavable and volatile substances and to maximize the efficiency of the binder system, and the relevant properties, as named above, of the phenol-formaldehyde resins for the productions of mineral-fiber-based insulating products are to be maintained.

The objects of the invention are in particular to furnish phenol-formaldehyde resins which have the required properties for use as binders for mineral-fiber-based insulating products, such as adequate stability and adequate water-solubility of the resins, and which furnish resins and binders that exhibit essentially no or only very slight formaldehyde separation, the least possible emission of amines and ammonia, and thus also enhanced efficiency, and the use of urea as a formaldehyde collector and thus the creation of volatile and potentially toxic materials by reaction of urea contained in the resin or the binder is avoided.

To stabilize phenol-formaldehyde resins which are to be used as binders for mineral-fiber-based insulating products, the addition of a boron salt, such as borax, in an early stage of the condensation is proposed, for instance in U.S. Pat. No. 6,881,814. By this means, the stability in particular of both the (uncured) basic resin and the premixture, which is a mixture of basic resin and urea as a formaldehyde collector, can be attained. Although by the modification of this resin the desired improvement and stability can be achieved, this does not overcome the problems that are caused by the use of urea as a formaldehyde collector.

It has now been discovered that the objects of the invention can be attained by a phenol-formaldehyde resin of the kind described below.

The aforementioned objects of the invention are attained in particular by a phenol-formaldehyde resin, which can be obtained by alkalinically catalyzed condensation of phenol and formaldehyde in the presence of at least one salt of inorganic acids, and neutralization by means of an inorganic or organic acid following the condensation, wherein the production takes place with the addition of at least one compound of the formula R¹—(CH₂)ₙ—R², in which R¹ and R², independently of one another, stand for —C(O)R, —COOR, —CN, or —NO₂, and R represents H or CH₃, and n has the value of 1 or 2.

The resins according to the invention may have a molar ratio of phenol to formaldehyde of 1.5 to 3.5; molar ratios of 2.0 to 3.0 are preferred.

As catalysts for the alkaline condensation, the inorganic and organic catalysts known in the art can be employed, such as the inorganic hydroxides NaOH, KOH, LiOH, Mg(OH)₂, Ca(OH)₂, and Ba(OH)₂, and the organic amines dimethylethanolamine and triethylamine. Mixtures of the catalysts can also be employed, such as mixtures of organic and inorganic catalysts, mixtures of various organic catalysts, and mixtures of various inorganic catalysts. As the salt of inorganic acids, the salts described in U.S. Pat. No. 6,881,814 can be used, and especially preferably, borax is used; the salt is advantageously present in a quantity of 0.5 to 6.0 wt.-% on an anhydrous basis, referred to the total weight of the reaction mixture. The borax used according to the invention may be either borax with crystal water, such as the decahydrate, or anhydrous borax.

The acids used for the neutralization are inorganic or organic acids which are known for this purpose in the art, and for the present invention they can be classified in two categories: If the binder according to the invention is intended essentially to be not only urea-free but also nitrogen-free, then acids which in turn likewise contain no nitrogen atoms are preferred, such as boric acid, sulfuric acid, phosphoric acid, hydrochloric acid, citric acid, and p-toluenesulfonic acid. If nitrogen-containing compounds are permitted in the binder according the invention that is essentially urea-free, then acids, such as nitric acid, ammonium sulfate, ammonium nitrate and amidosulfuric acid, which in turn contain nitrogen atoms, can advantageously be used. The prerequisite for using nitrogen-containing compounds is that under pyrolysis conditions, these compounds so not lead significantly to the formation of toxic compounds, such as methyl isocyanate.

An essential requirement for the phenol-formaldehyde resins of the invention is the combination, used in the condensation, of salt of an inorganic acid and at least one compound of the formula R¹—(CH₂)ₙ—R² (1), in which R¹ and R², independently of one another, stand for —C(O)R, —COOR, —CN or —NO₂, and R represents H or CH₃, and n has the value of 1 or 2. Preferably, this is a compound of the above formula (1) in which R¹ and R², independently of one another, stand for —C(O)R or —COOR, and for example, dicarbonyl compounds such as acetylacetone, methyl acetoacetate and 4-oxopentanal are especially preferred.

Polyketones are already employed in pressing and forming compound resins (such as in JP 63270720, JP 63289055, and JP 2124917). These are systems in which the ketones react with aromatic aldehydes. These resins do not have the desired water dilutability but instead must be dissolved in organic solvents.

Without inorganic salt, the storage stability is insufficient, for instance being less than one week. However, it has surprisingly been found that the combination of inorganic salt and a compound of the formula R¹—(CH₂)ₙ—R² leads to resins which not only have both adequate stability and adequate water solubility but also have a low formaldehyde value, which normally can be attained only with urea-modified resins (for instance less than 5%, preferably less than 1%).

The storage stability is preserved for one week, preferably two weeks, and highly preferably three weeks.

The compound of formula (1), in which the substituents have the general meanings given above, is present in the reaction mixture in a quantity of from 0.1 to 15 wt.-%, referred to the total weight of the reaction mixture. The term “reaction mixture” includes phenol, formaldehyde, inorganic salt, the compound of formula (1), and neutralization acid.

The method for producing a phenol-formaldehyde resin according to the invention essentially includes the steps of alkaline condensation of phenol and formaldehyde with the addition of a salt of an inorganic acid and an ensuing neutralization with an inorganic or organic acid, and before the step of the neutralization, at least one compound of formula (1), in which the substituents have the above-named general meanings, is added.

The phenol-formaldehyde resins according to the invention are used as binders, in particular as binders for insulating products that contain mineral fibers. The resins and the binder have no, or no significant, emission of ammonia and no, or no substantial, emission of formaldehyde. They can be modified in the usual way by reactive extender material and can be made fire-retardant by the addition of suitable additives, such as phosphates. Nitrogen-containing compounds, such as melamine or urea, are technically possible but not preferred in terms of the invention. Moreover, the borates also have a fire-retardant effect.

In use as binders, the phenol-formaldehyde resin of the invention, optionally with the addition of known required additives, such as silanes (for instance, aminopropylsilane), dust binder oil (such as Sasol HydroWax 88, HydroWax 82, HydroWax 296), ammonia (ammonia is prior art but not absolutely necessary and not preferred in terms of the invention), other hardeners (such as ammonium sulfate and formic acid), is used in aqueous solution in the usual concentration in order thereby, in a manner known per se, to spray or saturate the mineral fibers. Following that, the curing of the resin takes place at elevated temperature, in order to produce the insulating products containing mineral fibers, with a binder on the basis of the phenol-formaldehyde resin according to the invention. The insulating products containing mineral fibers that are thus produced contain the binder according to the invention, optionally in mixture with additives in a quantity of from 1 to 10 wt.-%.

For producing phenol-formaldehyde resins according to the invention, essentially the following method is employed:
1. supplying phenol, water, and the salt of the inorganic acid and of the alkaline catalyst;
2. heating the reactor contents to 30° C. to 50° C., often to 40° C.;
3. supplying formaldehyde, in which typically a temperature rise to approximately 60° C. takes place;
4. reacting the reaction mixture up to a predefined stopping point, for instance to a desired free phenol content for instance below 5% and preferably below 3%;
5. cooling the resin solution and adding at least one compound of the formula R¹—(CH₂)ₙ—R², in which the substituents have the above-listed meanings;
6. further condensing the thus-obtained reaction mixture at a moderate temperature of from 20° C. to 60° C., for instance approximately 40° C.;
7. neutralizing the reaction mixture with an acid;
8. cooling of the thus-obtained resin to an optimal storage temperature, for instance of 60° C. or less, preferably 40° C. or less.

By this method, phenol-formaldehyde resins according to the invention were produced, and Examples 1 through 3B are described in detail below:

### EXAMPLE 1

564 g of phenol (of which 55 g is water) were mixed at room temperature with 79 g of borax (in the form of the decahydrate), 119 g of KOH, and 577 g of water. The reaction mixture was then heated to 40° C., and after that, 587 g of formalin (of which 262 g is water) were added, and a temperature rise to a maximum of 63° C. was observed. The reaction mixture was condensed at 60° C. to a predefined stopping point. Once the desired degree of condensation was reached, the reaction mixture was cooled down to 25° C., and after that temperature was reached, 15 g of acetylacetone were added carefully, and the reaction mixture was heated again, while being stirred, to 40° C. After approximately 1 minute at 40° C., neutralization was done with 59 g of boric acid, and the thus-obtained resin was cooled down to 20° C.

The resin thus obtained has the following specifications:

| | |
|---|---|
| Index of reaction (20° C.) (Brix) | 60.7 |
| Solid content (at 135° C./1 h) (wt.-%) | 39.9 |
| Free formaldehyde (directly after production) (wt.-%) | 6.2 |
| Free formaldehyde (after 24 h storage at 20° C.) (wt.-%) | 0.2 |
| Free phenol (wt.-%) | 1.2 |
| pH (20° C., undiluted) | 7.8 |
| Water tolerance (20° C., distilled water) | unlimited |
| Curing time (at 130° C., per DIN16916) | 203 s |

### EXAMPLE 2

457 g of phenol (of which 44 g is water) were mixed at room temperature with 50 g of borax (in the form of the decahydrate), 80 g of LiOH (of which 40 g is water), and 680 g of water. The reaction mixture was then heated to 40° C., and after that, 594 g of formalin (of which 265 g is water) were added, and a temperature rise to a maximum of 63° C. was observed. The reaction mixture was condensed at 60° C. to a predefined stopping point. Once the desired degree of condensation was reached, the reaction mixture was cooled down to 25° C., and after that temperature was reached, 100 g of acetylacetone were added carefully, and the reaction mixture was heated again, while being stirred, to 40° C. After approximately 1 minute at 40° C., neutralization was done with 50 g of boric acid, and the thus-obtained resin was cooled down to 20° C.

The resin thus obtained has the following specifications:

| | |
|---|---|
| Index of reaction (20° C.) (Brix) | 58.6 |
| Solid content (at 135° C./1 h) (wt.-%) | 39.9 |
| Free formaldehyde (directly after production) (wt.-%) | 1.5 |
| Free formaldehyde (after 24 h storage at 20° C.) (wt.-%) | 1.4 |
| Free phenol (wt.-%) | 0.2 |
| pH (20° C., undiluted) | 7.8 |
| Water tolerance (20° C., distilled water) | unlimited |
| Curing time (at 130° C., per DIN16916) | 234 s |

### EXAMPLES 3A AND 3B

571 g of phenol (of which 55 g is water) were mixed at room temperature with 40 g of borax (in the form of the decahydrate), 70 g of NaOH (of which 35 g is water), and 564 g of water. The reaction mixture was then heated to 40° C., and after that, 696 g of formalin (of which 310 g is water) were added, and a temperature rise to a maximum of 63° C. was observed. The reaction mixture was condensed at 60° C. to a predefined stopping point. Once the desired degree of condensation was reached, the reaction mixture was cooled down to 25° C. After this temperature was reached, the reaction mixture was divided into two parts, and 40 g of methyl acetoacetate were added carefully to reaction mixture A, and 40 g of acetylacetone were added to reaction mixture B. Both the reaction mixture A and the reaction mixture B were heated once again, while being stirred, to 40° C. After approximately 1 minute at 40° C., neutralization was done with 20 g of boric acid, and the thus-obtained resin was cooled down to 20° C.

The resins thus obtained have the following specifications:

| | 3A | 3B |
|---|---|---|
| Index of reaction (20° C.) (Brix) | 62.8 | 62.5 |
| Solid content (at 135° C./1 h) (wt.-%) | 42.8 | 43.6 |
| Free formaldehyde (directly after production) | 0.7 | 0.6 |
| (wt.-%) | | |
| Free formaldehyde (after 24 h storage at 20° C.) | 0.7 | 0.6 |
| (wt.-%) | | |
| Free phenol (wt.-%) | 0.9 | 0.9 |
| pH (20° C., undiluted) | 7.6 | 7.3 |
| Water tolerance (20° C., distilled water) | unlimited | unlimited |
| Curing time (at 130° C., per DIN16916) | 186 s | 221 s |

Further phenol-formaldehyde resins according to the invention can be found in the following table:

| | Molar ratio | | Salt of the | Compund of | |
|---|---|---|---|---|---|
| | of phenol to | Catalyst | inorganic | formula 1 | |
| Resin | formaldehyde | (wt.-%) | acid (wt.-%) | (wt.-%) | Acid (wt.-%) |
| 1 | 2.0 | KOH/3.0 | Borax**/4.0 | Acetylacetone/0.75 | Boric acid/3.0 |
| 2 | 2.5 | LiOH/2.0 | Borax**/2.5 | Acetylacetone/5.0 | Boric acid/2.0 |
| 4 | 2.35 | NaOH/1.74 | Borax**/1.98 | Acetylacetone/1.98 | Boric acid/0.99 |
| 5 | 2.0 | KOH/3.0 | Borax**/4.0 | Methyl | Boric acid/3.0 |
| | | | | acetylacetate/0.75 | |
| 6 | 2.5 | LiOH/2.0 | Borax**/2.5 | 4-Oxopentanal/5.0 | Citric acid/2.0 |
| 7 | 3.0 | TEA*/2.0 | Borax**/0.75 | Acetylacetone/10.0 | Phosphoric acid/0.5 |
| 8 | 3.0 | TEA*/0.75 | Borax**/0.75 | Acetylacetone/10.0 | Boric acid/0.5 |

*TEA = triethylamine
**in the form of the decahydrate

Using the phenol-formaldehyde resins thus produced as binders, optionally with the addition of industrially known additives, mineral-fiber-based insulating products that meet the following requirements can be produced in a manner known per se:

maximizing the efficiency of the binder with the greatest possible reduction of volatile and separable substances during the production process of the insulating materials;

minimizing separable and volatile substances from the finished end products;

the highest possible chemical stability under relatively high thermal stresses, especially in terms of the creation of toxic nitrogen compounds, so that such compounds do not occur or occur only in quantities that are below the detection limit of the various compounds, which detection limit as a rule is below the limit values relevant to human health; and

preserving production-relevant properties.

1. A phenol-formaldehyde resin, which can be obtained by alkalinically catalyzed condensation of phenol and formaldehyde in the presence of at least one salt of inorganic acids, and neutralization by means of an inorganic or organic acid following the condensation, wherein the production takes place with the addition of at least one compound of the formula R¹—(CH₂)ₙ—R², in which R¹ and R², independently of one another, stand for —C(O)R, —COOR, —CN, or —NO₂, and R represents H or CH₃, and n has the value of 1 or 2.

2. The phenol-formaldehyde resin as defined by claim 1, wherein the salt of inorganic acids is a borate, preferably borax.

3. The phenol-formaldehyde resin as defined by claim 1, wherein the inorganic acid salt is present in a quantity of from 0.5 to 6.0 wt.-% (anhydrous), referred to the total weight of the reaction mixture.

4. The phenol-formaldehyde resin as defined by claim 1, wherein at least one compound of the formula R¹—(CH₂)ₙ—R² (1) is used, in which R¹ and R², independently of one another, stand for —C(O)R or —COOR.

5. The phenol-formaldehyde resin as defined by claim 4, wherein the compound of formula (1) is acetylacetone, methyl acetoacetate, or 4-oxopentanal.

6. The phenol-formaldehyde resin as defined by claim 1, wherein the compound of formula (1) is present in the quantity of from 0.5 to 15 wt.-%, referred to the total weight of the reaction mixture.

7. The phenol-formaldehyde resin as defined by claim 1, wherein the molar ratio of phenol to formaldehyde is from 2.0 to 3.0.

8. A method for producing a phenol-formaldehyde resin, comprising the steps of the alkaline condensation of phenol and formaldehyde with the addition of at least one salt of an inorganic acid and an ensuing neutralization with an inorganic or organic acid, wherein before the step of the neutralization, at least one compound of the formula R¹—(CH₂)ₙ—R² (1), in which R¹ and R², independently of one another, stand for —C(O)R, —COOR, —CN, or —NO₂, and R represents H or CH₃, and n has the value of 1 or 2, is added.

9. The use of a phenol-formaldehyde resin, as it is defined in claim 1, optionally with the addition of additives, as binders.

10. The use of a phenol-formaldehyde resin as defined by claim 9 for mineral-fiber-based insulating products.

11. A binder, including a phenol-formaldehyde resin, as it is defined in claim 1, optionally in mixture with additives.

12. Mineral-fiber-based insulating products, wherein as a binder they contain a binder on the basis of the phenol-formaldehyde resin, as it is defined in claim 1.

13. Mineral-fiber-based insulating products as defined by claim 12, wherein the insulating products contain a content of binders on the basis of the phenol-formaldehyde resins, in a quantity of from 1 to 10 wt.-% in the insulating products.
